(19) United States
(12) Patent Application Publication
(10) Pub. No.: US 2012/0147627 A1
(43) Pub. Date: Jun. 14, 2012

(54) LIGHT GUIDE MODULE, BACKLIGHT MODULE AND FABRICATION METHOD OF LIGHT GUIDE MODULE

(75) Inventor: Bo-Chih Pan, Hsin-Chu (TW)

(73) Assignee: YOUNG LIGHTING TECHNOLOGY CORPORATION, Hsin-Chu (TW)

(21) Appl. No.: 13/272,224

(22) Filed: Oct. 13, 2011

(30) Foreign Application Priority Data
Dec. 8, 2010 (TW) 099142825

(51) Int. Cl. F21V 8/00; B32B 38/14; B32B 37/14; B32B 37/12

(52) U.S. Cl. 362/624; 156/60; 156/277

(57) ABSTRACT

A light guide module includes a light guide plate and a diffuse reflector. The light guide plate has a light incidence surface, a light exiting surface, and a bottom surface, wherein the light exiting surface is opposite to the bottom surface, and the light incidence surface is connected with the light exiting surface and the bottom surface. The diffuse reflector is secured to the bottom surface of the light guide plate by an adhesive pattern layer, wherein the adhesive pattern layer is formed by a plurality of light-transmissive adhesive gels, and these light-transmissive adhesive gels do not contain any diffusive particles. A backlight module using the light guide module mentioned above and a fabricating method for the light guide module are also provided.

### CROSS-REFERENCE TO RELATED APPLICATION

This application claims the priority benefit of Taiwan application serial no. 099142825, filed on Dec. 8, 2010. The entirety of the above-mentioned patent application is hereby incorporated by reference herein and made a part of this specification.

### BACKGROUND OF THE INVENTION

1. Field of the Invention

The invention relates to a light guide module and a fabricating method of the light guide module, more particularly to a backlight module having the light guide module, and a fabrication method thereof.

2. Description of Related Art

As shown in FIG. 1A, the backlight module 60 includes a light source 62, a light guide plate 68, a patterned adhesive layer 78, and a reflection sheet 76. The light guide plate 68 includes an incidence surface 66, a bottom surface 70, a light exiting surface 72, wherein the light source 62 is disposed beside the incidence surface 66 of the light guide plate 68. The reflection sheet 76 is secured to the bottom surface 70 of the light guide plate 68 through the patterned adhesive layer 78, wherein the patterned adhesive layer 78 includes diffusive particles. Accordingly, when the light beam L1 from the light source 62 transmitting in the light guide plate 68 to the patterned adhesive layer 78, the light beam L1 is diffused by the patterned adhesive layer 78, as shown in FIG. 1A.

Continuing to FIG. 1B, the backlight module 60′ includes a light source 62, a light guide plate 68, an adhesive layer 73, a diffuse pattern layer 71 and a reflection sheet 76, wherein the diffuse pattern layer 71 is formed by using a diffusive glue, paint or ink. Similarly, the light guide plate 68 includes an incidence surface 66, a bottom surface 70, a light exiting surface 72, and the light source 62 is disposed beside the incidence surface 66 of the light, guide plate 68. The diffuse pattern layer 71 is disposed on the reflection sheet 76, and the reflection sheet 76 including the diffuse pattern layer 71 thereon is bonded to the bottom surface 70 of the light guide plate 68 through the patterned adhesive layer 73, wherein the diffuse pattern layer 71 includes diffusive particles.

In the backlight modules 60, 60′, since the patterned adhesive layer 78 and the diffuse pattern layer 71 include diffusive particles, during the formation of the patterned adhesive layer 78 and the diffusive pattern 71 through screen printing or other similar methods, the diffusive particles are easily obstructed in the holes of the mesh. Accordingly, the distributions of the diffusive particles, the patterned adhesive layer 78 and the diffuse pattern layer 71 are not even. More particularly, when the dimension of the patterned adhesive layer 78 and the diffuse pattern layer 71 progressively reduces as the thickness of the backlight module becomes thinner, the mesh holes must also become smaller. Accordingly, the mesh holes are easily obstructed by the diffusive particles, and the diffusive particles are unevenly distributed in the patterned adhesive layer 78 and the diffuse pattern layer 71. Hence, limited by the traditional screen printing process, the dimensions of the patterned adhesive layer 78 and the diffusive pattern layer 71 doped with the diffusive particles may not be effectively reduced and the optical performance of the backlight source provided by the backlight module may not be enhanced.

### SUMMARY OF THE DISCLOSURE

The disclosure is directed to a light guide module having a desirable optical performance.

The disclosure is directed to a backlight module, using the abovementioned light guide module to provide a more uniform backlight source.

The disclosure is directed to a method of fabricating a light guide module for fabricating the abovementioned light guide module.

The invention and certain merits provided by the invention may be better understood by way of the following exemplary embodiments.

To achieve at least one of the above-mentioned objectives, an exemplary embodiment of the disclosure provides a light guide module that includes a light guide pate and a diffuse reflector. The light guide plate includes a light incidence surface, a light exiting surface, and a bottom surface, wherein the light exiting surface is opposite to the bottom surface, and the light incidence surface is connected with the light exiting surface and the bottom surface. The diffuse reflector is secured to the bottom surface of the light guide plate by an adhesive pattern layer, wherein the adhesive pattern layer includes a plurality of light-transmissive adhesive gels, and the light-transmissive adhesive gels do not contain diffusive particles.

An exemplary embodiment of the disclosure provides a backlight module including a light guide plate, a light source, and a diffuse reflector. The light guide plate includes a light incidence surface, a light exiting surface, and a bottom surface, wherein the light exiting surface is opposite to the bottom surface, and the light incidence surface is connected with the light exiting surface and the bottom surface. The light source is disposed at a side of the incidence surface of the light guide plate, and the light source is capable of providing a light beam. The diffuse reflector is secured to the bottom surface of the light guide plate by an adhesive pattern layer, wherein the adhesive pattern layer includes a plurality of light-transmissive adhesive gels, and the light-transmissive adhesive gels do not contain diffusive particles.

According to an exemplary embodiment of the disclosure, the diffuse reflector includes a foam-molding type of white reflector or a reflector having a plurality of microstructures, wherein the foam-molding type of white reflector and the reflector having the microstructures are respectively integrally formed.

According to an exemplary embodiment of the disclosure, a refractive index of the light-transmissive adhesive gels is greater than the refractive index of air.

According to an exemplary embodiment of the disclosure, a refractive index of the light-transmissive adhesive gels is greater than or equal to a refractive index of the light guide plate.

According to an exemplary embodiment of the disclosure, a density of the light-transmissive adhesive gels increases as a distance of the light-transmissive adhesive gels from the light incidence surface increases.

According to an exemplary embodiment of the disclosure, a size of the light-transmissive adhesive gels increases as a distance of the light-transmissive adhesive gels from the light incidence surface increases.

According to an exemplary embodiment of the disclosure, the light guide plate includes a flat type light guide plate or a wedge shape light guide plate.

According to an exemplary embodiment of the disclosure, the light beam of the light source passes through the light incidence surface to enter the light guide plate, and when the light beam transmitting in the light guide plate is transmitted to the bottom surface contacting with the light-transmissive adhesive gels, the light beam is emitted from the bottom surface, enters into the light-transmissive adhesive gels, and is transmitted to the diffuse reflector contacting with the light-transmissive adhesive gel. The light beam is diffused by the diffuse reflector and is reflected to the light guide plate, and is emitted from the light exiting surface.

An exemplary embodiment of the disclosure provides a method of fabricating a light guide module. The method includes providing a light guide plate, wherein the light guide plate includes a light incidence surface, a light exiting surface, and a bottom surface. A diffuse reflector is also provided. Thereafter, an adhesive pattern layer is applied to secure the diffuse reflector to the bottom surface of the light guide plate, wherein the adhesive pattern layer is formed with a plurality of light-transmissive adhesive gels, and the light-transmissive adhesive gels do not contain diffusive particles.

According to an exemplary embodiment of the disclosure, securing the diffuse reflector to the bottom surface of the light guide plate includes forming the adhesive pattern layer on the diffuse reflector, and disposing the diffuse reflector to the bottom surface of the light guide plate, wherein the bottom surface has the adhesive pattern layer thereon. In one exemplary embodiment, the adhesive pattern layer is formed on the diffuse reflector by performing a screen printing process, a printing process, or a coating process.

According to an exemplary embodiment of the disclosure, securing the diffuse reflector to the bottom surface of the light guide plate includes forming the adhesive pattern layer to the bottom surface of the light guide plate. The diffuse reflector is disposed to the bottom surface of the light guide plate including the adhesive pattern layer, and the diffuse reflector is secured to the light guide plate through the adhesive pattern layer. In one exemplary embodiment, the adhesive pattern layer is formed on the bottom surface of the light guide plate by performing a screen printing process, a printing process, or a coating process.

Accordingly, the embodiment or the embodiments of the invention may have at least one of the advantages, the adhesive pattern layer constructed with the plurality of the light-transmissive adhesive gels is applied to secure the diffuse reflector to the bottom surface of the light guide plate, wherein the light-transmissive adhesive gels do not contain any diffusive particles. Hence, the formation of the adhesive pattern layer is not limited by the size of the diffusive particles, and the adhesive pattern layer with a smaller dimension and a more even distribution of the light-transmissive adhesive gels is formed. Hence, the light field distribution of the light beam emitted from the light exiting surface of the light guide plate may have better light uniformity. In other words, the backlight module provides a backlight source with better light uniformity. Moreover, the backlight module applies a light-transmissive adhesive gels having adhesive property to bond the light guide plate and the diffuse reflector together. Accordingly, a backlight source with better light uniformity is provided. Moreover, a fabrication method of a light guide module for forming a light guide module with at least one of the above-mentioned merits is provided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIGS. 1A and 1B are schematic diagrams illustrating a conventional backlight module.

FIG. 2A is a schematic, partial view diagram of a backlight module according to an exemplary embodiment of the disclosure.

FIG. 2B is a partial enlarged view of the backlight module in FIG. 2A.

FIG. 3A is a schematic, partial view illustrating the backlight module of FIG. 2A applying another type of reflector having a plurality of microstructures.

FIG. 3B is a schematic, partial view illustrating the backlight module of FIG. 2A applying another type of reflector having a plurality of microstructures.

FIG. 3C is a schematic, partial view illustrating the backlight module of FIG. 2A applying another type of reflector having a plurality of microstructures.

FIG. 3D is a schematic, partial view illustrating the backlight module of FIG. 2A applying another type of reflector having a plurality of microstructures.

FIG. 4 is a schematic, partial view diagram of a backlight module according to an exemplary embodiment of the disclosure.

FIG. 5 is a schematic, partial view of a backlight module according to an exemplary embodiment of the disclosure.

FIGS. 6A to 6C are schematic views showing selected steps for the fabrication of a light guide module according to an exemplary embodiment of the invention.

FIGS. 7A to 7C are schematic views showing selected steps for the fabrication of a light guide module according to an exemplary embodiment of the invention.

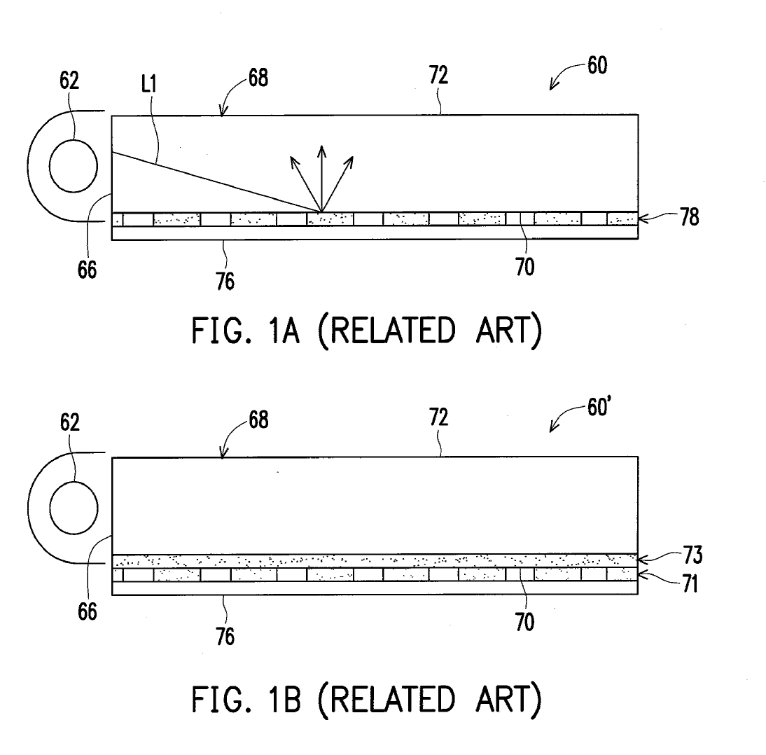

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” or “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

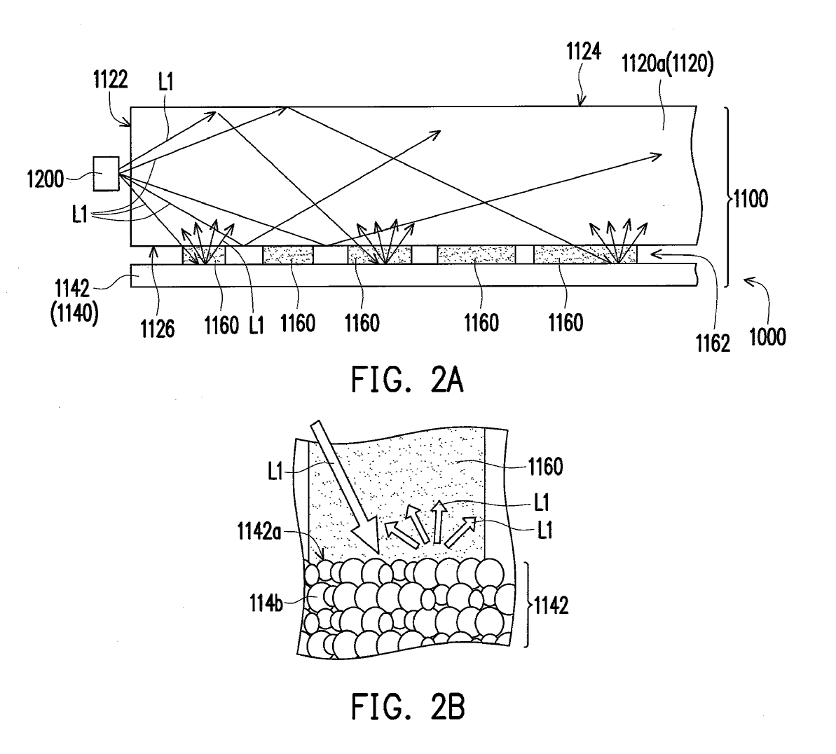

Referring to both FIGS. 2A and 2B, the backlight module 1000 of this exemplary embodiment includes a light guide module 1100 and a light source 1200. The light guide module 1100 includes a light guide plate 1120, and a diffuse reflector 1140. The light guide plate 1120 includes a light incidence surface 1122, a light exiting surface 1124, and a bottom surface 1126, wherein the light exiting surface 1124 is opposite to the bottom surface 1126, and the light incidence surface 1122 is connected with the light exiting surface 1124 and the bottom surface 1126. Although in this exemplary embodiment, the light guide plate 1120 is, for example, a flat type light guide plate 1120a, the exemplary embodiment is presented by way of example and not by way of limitation. The light guide plate 1120 may apply other possible light guide structures, which will be further described in the disclosure.

The light source 1200 is disposed beside the light incidence surface 1122 of the light guide plate 1120. Further, the light source 1200 is capable of providing a light beam L1, as shown in FIG. 2A. In this exemplary embodiment, the light source 1200 may be a light emitting diode or a cold cathode ray fluorescent lamp. Alternatively speaking, the invention does not limit the type of light source 1200. Moreover, the light beam L1 from the light source 1200 passes through the light incidence surface 1122 to enter the interior of the light guide plate 1120, as shown in FIG. 2A.

Referring to FIGS. 2A and 2B, in the light guide module 1100, the diffuse reflector 1140 is secured to the bottom surface 1126 of the light guide plate 1120 by an adhesive pattern layer 1162, wherein the adhesive pattern layer 1162 is formed with a plurality of light-transmissive adhesive gels 1160, and these light-transmissive adhesive gels 1162 do not contain diffusive particles. In this exemplary embodiment, the diffuse reflector 1140 may be a white reflection sheet, for example. However, the diffuse reflector 1140 may be other types of reflection sheet. More specifically, the white reflection sheet 1142 is a reflection sheet formed by the foam molding technique. Hence, the white reflection sheet 1142 is generated with a foaming surface 1142a, as showing in FIG. 2B. In this exemplary embodiment, the light beam L1 is transmitted to the foaming surface 1142a, and the light beam L1 is diffused and concurrently reflected by the foaming surface 1142a, as shown in FIGS. 2A and 2B. Moreover, the foaming structures 1142b and the foaming surface 1142a of the white reflection sheet 1142, and white reflection sheet 1142 are constructed with the same material. In other words, the foaming surface 1142a, the foaming structure 1142b, and the white reflection sheet 1142 are integrally formed.

In this exemplary embodiment, the refractive index of the light-transmissive adhesive gels 1160 is greater than the refractive index of air. Since the refractive index of the light guide plate 1120 is greater than the refractive index of the air outside the light guide plate 1120, the total internal reflection of the light beam L1 formed inside the light guide plate 1120 needs to be destroyed for the light beam L1 to be emitted to the exterior of the light guide plate 1120. More particularly, the refractive index of the light-transmissive adhesive gels 1160 is substantially similar to the refractive index of the light guide plate 1120. Accordingly, as the light beam L1 transmitting inside the light guide plate 1120 is transmitted to the bottom surface 1126 contacting with the light-transmissive adhesive gels 1160, the light beam L1 is emitted through the bottom surface 1126 to enter into the interior of the light-transmissive adhesive gels 1160. Concurrently, the light beam L1 is transmitted to the diffuse reflector 1140 contacting with the light-transmissive adhesive gels 1160, wherein the diffuse reflector 1140 may be the described white reflection sheet 1142. Hence, as the light beam L1 is transmitted to the diffuse reflector 1140, the light beam L1 is diffused by the diffuse reflector 1140. Concurrently, the light beam L1 is reflected by the diffuse reflector 1140 to the light guide plate 1120, such that the light beam L1 may be emitted from the light exiting surface 1124 of the light guide plate 1120, as shown in FIGS. 2A and 2B. In this exemplary embodiment, the refractive index of the light-transmissive adhesive gels 1160 is substantially greater than or equal to the refractive index of the light guide plate 1120.

In order to make the light beam L1 emitting from the light exiting surface 1124 of the light guide plate 1120 display with better light uniformity, the light-transmissive adhesive gels 1160 are provided in the form of the adhesive pattern layer 1162 in the exemplary embodiment of the disclosure. Hence, the light beam L1 emitted from the light exiting surface 1124 of the light guide plate 1120 may have better light uniformity. In this exemplary embodiment, the size of the light-transmissive adhesive gels 1160 is larger as the distance of the light-transmissive adhesive gels 1160 from the light incidence surface 1122 increases as shown in FIG. 2A.

In this exemplary embodiment, the adhesive pattern layer 1162 is formed by the method of, for example, screen printing, printing or coating to apply the light-transmissive adhesive gels 1160 on the diffuse reflector 1140 or the light guide plate 1120 to form the adhesive pattern layer 1162.

Moreover, since the light guide plate 1120 and the diffuse reflector 1140 are bonded together by the light-transmissive adhesive gels 1160 having adhesive property, the backlight source provided by the backlight module 1000 of the exemplary embodiment in the invention mitigates the problem of mura. For example, if the back plane (not shown) inside the backlight module is not level and smooth, the reflection sheet disposed on the back plane is not level either. Hence, the reflection sheet may not effectively and uniformly reflect the light beam emitted from the bottom surface to the interior of the light guide plate. Accordingly, the light source provided by the traditional backlight module would easily result in the mura phenomenon. In other words, in the backlight module 1000 of the exemplary embodiment, a light source with desirable light uniformity is provided by applying the light-transmissive adhesive gels 1160 having adhesive property to bond the light guide plate 1120 and the diffuse reflector 1140 together.

In accordance to the above disclosure, the backlight module 1000 of the exemplary embodiment provides the diffuse reflector 1140 secured to the bottom surface 1126 of the light guide plate 1120 through the light-transmissive adhesive gels 1160, wherein the refractive index of the light-transmissive adhesive gels 1160 is greater than the refractive index of air. Hence, the total internal reflection of the interior of the light guide plate 1120 may be destroyed. Alternatively speaking, the light beam L1 enters into the light-transmissive adhesive gels 1160 through the bottom surface 1126 of the light guide plate 1120 and is concurrently diffused by the diffuse reflector 1140 in contact with the light-transmissive adhesive gels 1160 and reflected to the interior of the light guide plate 1120. The light beam L1 is then emitted out of the light exiting surface 1124 of the light guide plate 1120. Further, since the light-transmissive adhesive gels 1160 do not include any diffusive particles, the dimension of the adhesive pattern layer 1162 is not limited by the size of the diffusive particles, and a more evenly distribution of an adhesive pattern layer 1162 with a smaller dimension is formed. Hence, the light field distribution of the light beam L1 emitted from the light exiting surface 1124 appears to have better light uniformity. Alternatively speaking, the backlight module of the exemplary embodiment of the invention may provide a backlight source with better uniformity. Moreover, according to the backlight module 1000 of the exemplary embodiment of the invention, the light-transmissive adhesive gels 1160 having adhesive property are used for bonding the light guide panel 1120 and the diffuse reflector 1140 together to provide a backlight source with uniform brightness.

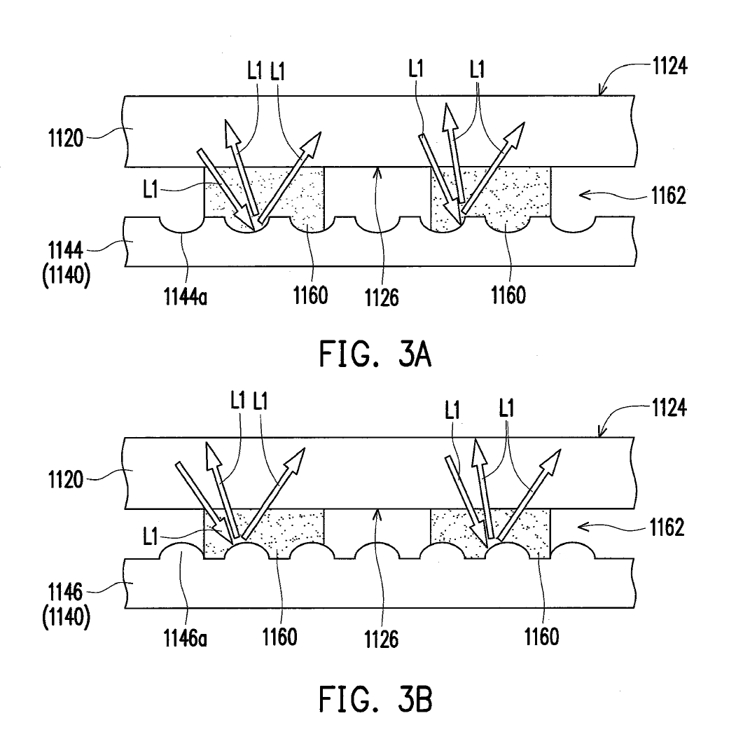

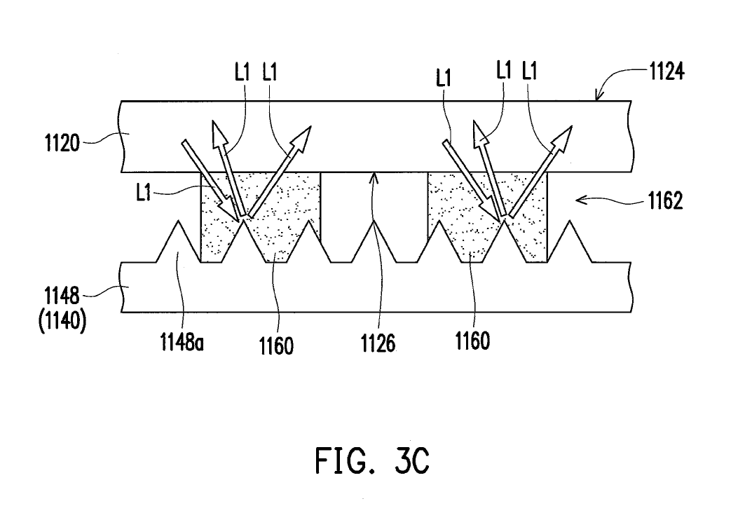

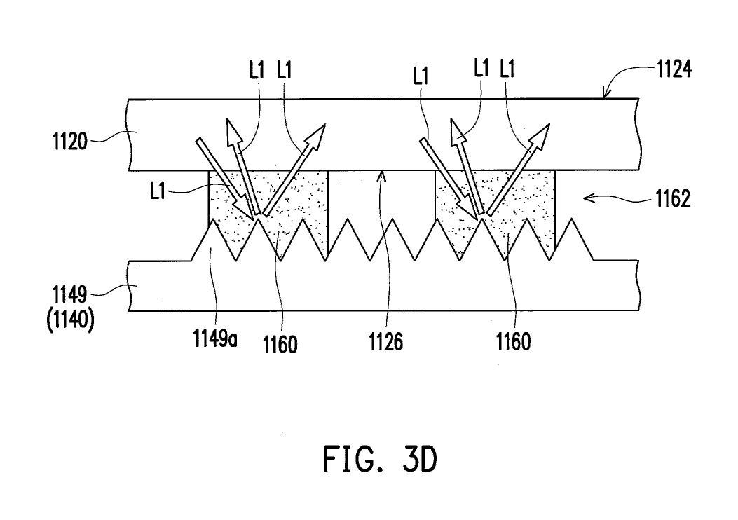

Further, in the backlight module 1000 disclosed above, a white reflection sheet 1142 is used as the diffuse reflector 1140; however, the diffuse reflector 1140, in other exemplary embodiments, may also apply the reflection plate 1144, 1146, 1148, 1149, as shown in FIGS. 3A to 3D. More specifically, referring to FIG. 3A, these microstructures 1144a are a plurality of indentations recessed in the reflection plate 1144. Accordingly, the light beam L1 emitted from the bottom surface 1126 of the light guide plate 1120 is transmitted to these microstructures 1144a, and the light beam L1 is diffused and concurrently reflected by these microstructures 1144a to the light guide plate 1120, as shown in FIG. 3A. Similarly, referring to FIG. 3B, the microstructures 1146a are protruded above the reflection plate 1146. Accordingly, as the light beam L1 is emitted from the bottom surface 1126 of the light guide plate 1120 and is transmitted to these microstructures 1146a, these microstructures 1146a similarly diffuse and simultaneously reflect the light beam L1 to the light guide plate 1120. Referring to FIG. 3D, these microstructures 1148a are, for example, silver-reflecting prism structures, and are continuously arranged. Referring to FIG. 3C, these microstructures 1149a are, for example, silver-reflecting prism structures, and are not continuously arranged. More specifically, as the light beam L1 emitted from the bottom surface of the light guide plate 1120 is transmitted to the microstructures 1148a, 1149a, these microstructures 1148a, 1149a diffuse and simultaneously reflect the light beam L1 to the light guide plate 1120. In this exemplary embodiment, the above-described microstructures 1144a, 1146a, 1148a, 1149a and the reflection plates 1144, 1146, 1148 and 1149 are formed with a same type of materials. Alternatively speaking, these microstructures 1144a, 1146a, 1148a, 1149a and the reflection plates 1144, 1146, 1148 and 1149 are integrally formed.

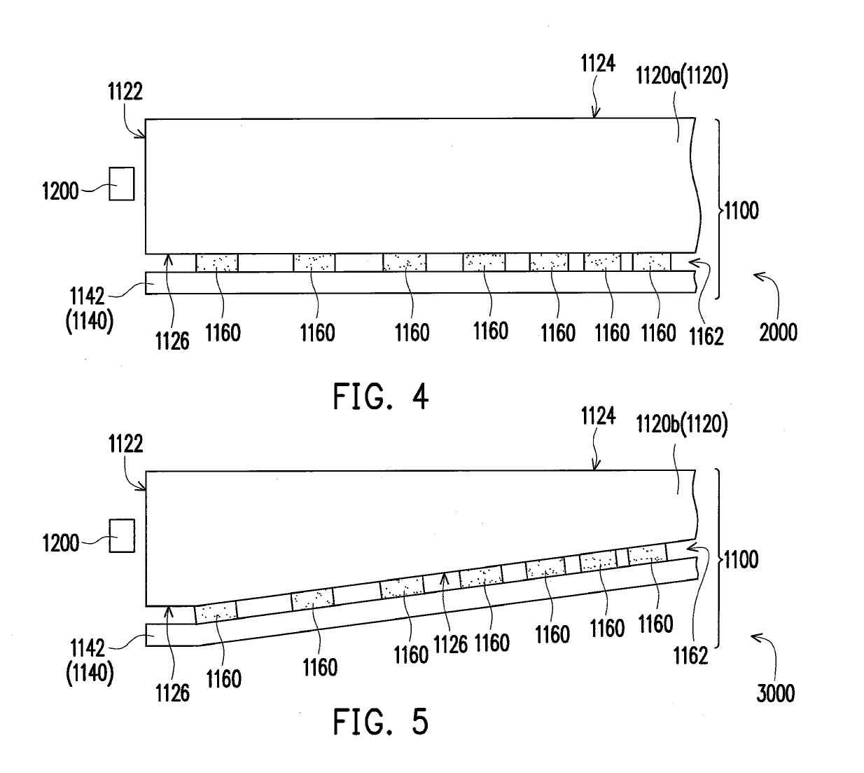

Referring to both FIG. 2A and FIG. 4, the backlight module 2000 of this exemplary embodiment and the previously disclosed backlight module 1000 are constructed based on the similar concept and with a similar structure. The difference between the two backlight modules lies in that the backlight module 2000 is formed with the light-transmissive adhesive gels 1160 having substantially similar dimensions, wherein the density of the light-transmissive adhesive gels 1160 increases as the distance of the light-transmissive adhesive gels 1160 from the light incidence surface 1122 increases. As shown in FIG. 4, the concepts behind the backlight module 1000 and the backlight module 2000 are the same, the backlight module 2000 encompasses similar advantages of the backlight module 1000. The back light module 2000 of this exemplary embodiment may apply the white reflection sheet 1142 or the reflection sheets 1144, 1146, 1148, 1149 respectively including the microstructures 1144a, 1146a, 1148a, 1149a.

Referring to both FIGS. 4 and 5, the backlight module 3000 of this exemplary embodiment and the previously disclosed backlight module 2000 are formed based on the same concept and with a similar structure. The difference between the two backlight modules lies in that the backlight module 3000 includes a wedge shape light guide plate 1120b, as shown in FIG. 5. Since the light guide plate 1120 is a wedge shape light guide plate 1120b, the diffuse reflector 1140 bonded with the light guide plate 1120 with the light-transmissive adhesive gels 1160 is curved along the bottom surface 1126 of the light guide plate 1120, as shown in FIG. 5. Since the backlight module 3000 of this exemplary embodiment and the disclosed backlight module 2000 are based on the same concept, the backlight module 3000 encompasses similar advantages of the backlight module 2000. The back light module 3000 of this exemplary embodiment may apply the white reflection sheet 1142 or the reflection sheets 1144, 1146, 1148, 1149 respectively including the microstructures 1144a, 1146a, 1148a, 1149a. Moreover, the adhesive pattern layer 1162 configured between the light guide plate 1120 and the diffuse reflector 1140 may also be arranged in a manner as shown in FIG. 2A.

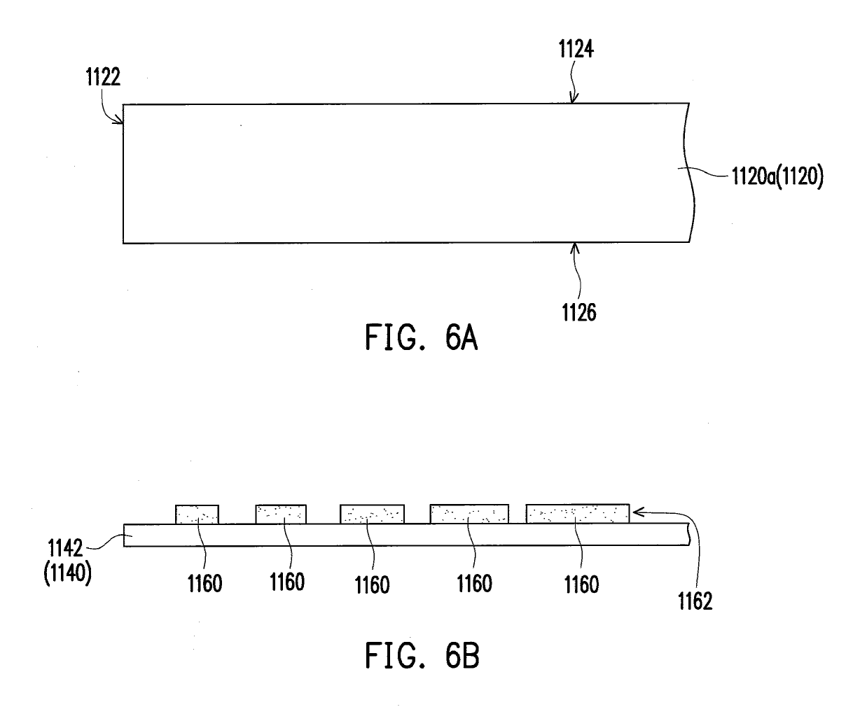

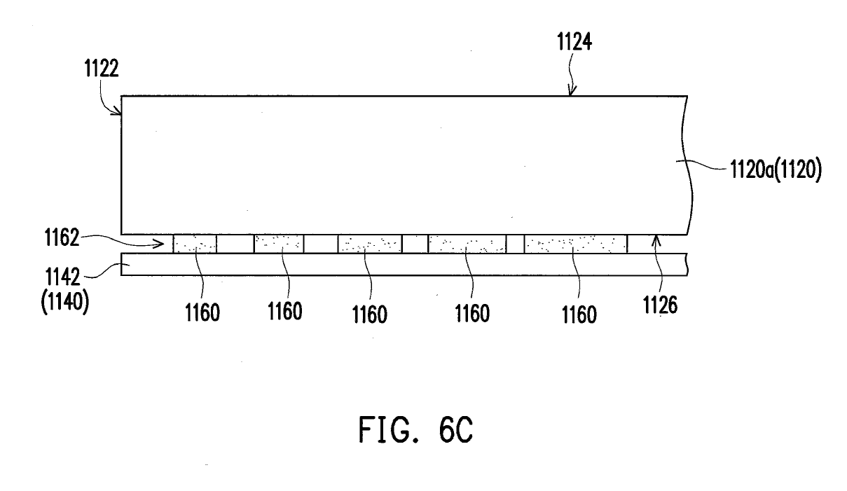

Accordingly, the invention also provides a fabrication method of a light guide module 1100, wherein the selected process steps of the fabrication method are illustrated in FIGS. 6A to 6C. More specifically, the fabrication method of a light guide module 1100 includes providing a light guide plate 1120, wherein the light guide plate 1120 includes a light incidence surface 1122, a light exiting surface 1124 and a bottom surface 1126, as shown in FIG. 6A.

Thereafter, a diffuse reflector 1140 is provided, as shown in FIG. 6B. An adhesive pattern layer 1162 is subsequently formed on the diffuse reflector 1140, wherein the adhesive pattern layer 1162 is formed with a plurality of light-transmissive adhesive gels 1160, and the light-transmissive adhesive gels 1160 do not include any diffusive particles, as shown in FIG. 6B. For example, the formation of the adhesive pattern layer 1162 on the diffuse reflector 1140 is accomplished via a screen printing process, a printing process or a coating process, in which the light-transmissive adhesive gels 1160 are applied on the diffuse reflector 1140 to form the adhesive pattern 1162, as shown in FIG. 6B.

The diffuse reflector 1140 is secured to the bottom surface 1126 of the light guide plate 1120 using the adhesive pattern layer 1162, as shown in FIG. 6C. In this exemplary embodiment, the adhesive pattern layer 1162 is first formed on the diffuse reflector 1140. Then, the diffuse reflector 1140 with the adhesive pattern layer 1162 is bonded to the light guide plate 1120, as shown in FIG. 6C. Since the adhesive pattern layer 1162 is first formed on the diffuse reflector 1140, and the diffuse reflector 1140 may construct with a flexible material, such as polyvinylchloride (PVC), polyethylene terephthalate (PET) or polycarbonate (PC), the diffusion reflector 1140 is applicable to a light guide plate with a non-level bottom surface (for example, an arc surface).

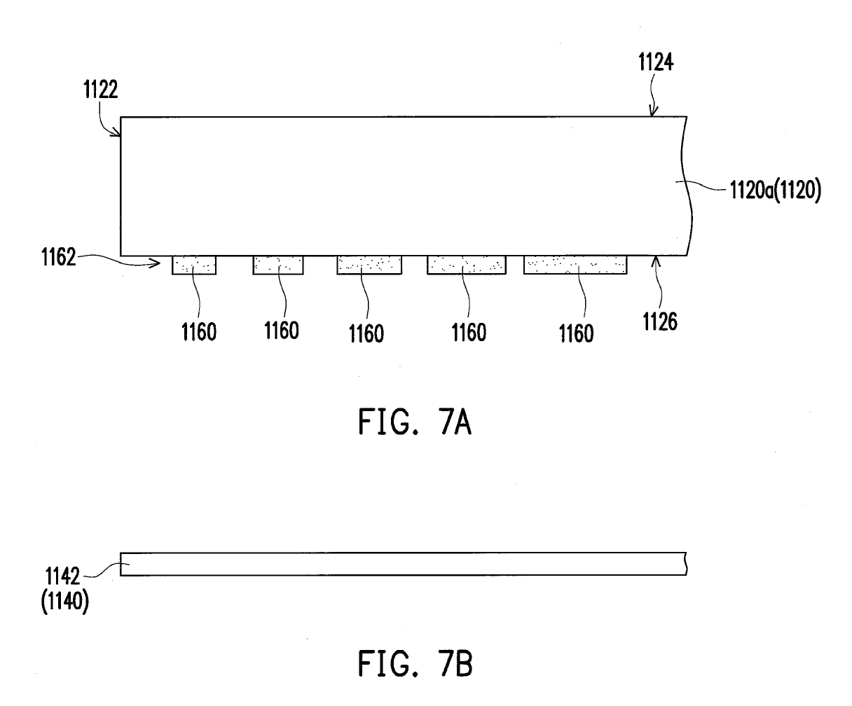

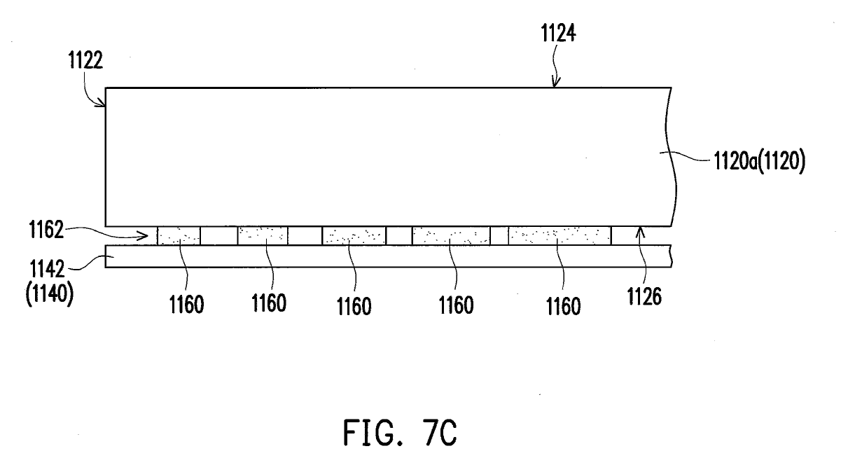

Referring to FIGS. 7A to 7C, more specifically, the fabrication method of a light guide module 1100 includes providing a light guide plate 1120, wherein the light guide plate 1120 includes a light incidence surface 1122, a light exiting surface 1124, and a bottom surface 1126, as shown in FIG. 7A. Thereafter, an adhesive pattern layer 1162 is formed on the bottom surface 1126 of the light guide plate 1120, wherein the adhesive pattern layer 1162 is constructed with a plurality of light-transmissive adhesive gels 1160, and the light-transmissive adhesive gels 1160 do not contain any diffusive particles, as shown in FIG. 7A. For example, forming the adhesive pattern layer 1162 on the bottom surface 1120 of the light guide plate 1120 is accomplished via a screen printing process, a printing process, or a coating process in which the light-transmissive adhesive gels 1160 are formed on the bottom surface 1126 of the light guide plate 1120, as shown in FIG. 7A.

Then, a diffuse reflector 1140 is provided, as shown in FIG. 7B. Thereafter, the adhesive pattern layer 1162 is used to secure the diffuse reflector 1140 to the bottom surface 1126 of the light guide plate 1120, as shown in FIG. 7C. In this exemplary embodiment, since the light-transmissive adhesive gels 1160 are already formed on the bottom surface 1126 of the light guide plate 1120, the diffuse reflector 1140 may dispose on the light guide plate 1120 with the adhesive pattern layer 1162 already disposed thereon, wherein the diffuse reflector 1140 and the light guide plate 1120 are secured with each other through the adhesive pattern layer 1162, as shown in FIG. 7C.

The light-transmissive adhesive gels 1160 do not include any diffuse particles. Hence, forming the adhesive pattern layer 1162 on the light guide plate 1120 or the diffuse reflector 1140 via the screen printing process, a printing process, or a coating process, the formation of the adhesive pattern layer 1162 may not be limited by the size of the diffusive particles, and a more even distribution of the adhesive pattern layer 1162 with a smaller dimension may be formed on the light guide plate 1120 or the diffuse reflector 1140.

According to the exemplary embodiments of the light guide module and the fabrication method of the light guide module, and the backlight module including the light guide module, the embodiment or the embodiments of the invention may have at least one of the advantages, the diffuse reflector is secured to the bottom surface of the light guide plate via the light-transmissive adhesive gels, wherein the refractive index of the light-transmissive adhesive gels is greater than the refractive index of air. Hence, the total internal refraction of the interior of the light guide plate may be destroyed. In other words, the light beam enters the light-transmissive adhesive gels through the bottom surface of the light guide plate. The light beam is diffused and reflected to the interior of the light guide plate by the diffuse reflector in contact with the light-transmissive adhesive gels, and is emitted from the light exiting surface of the light guide plate. Additionally, since the light-transmissive adhesive gels do not contain diffusive particles, the formation of adhesive pattern layer is not be limited by the size of the scattering particles, and may be formed with a smaller dimension and a more evenly distribution. Accordingly, the light field distribution of the light beam emitted from the light exiting surface of the light guide plate has a better light distribution. In other words, the backlight module of the exemplary embodiment of the invention may provide a backlight source with more desirable light uniformity. Furthermore, in the backlight module of the exemplary embodiments, by applying the light-transmissive adhesive gels having adhesive property to bond the light guide plate with the diffuse reflector, a back light source with desirable light uniformity is provided. The exemplary embodiments of the invention also provide a fabrication method of a light guide module to form a light guide module with at least the above-mentioned merits.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A light guide module, comprising:
a light guide plate, comprising a light incidence surface, a light exiting surface, and a bottom surface, wherein the light exiting surface is opposite to the light incidence surface, and the light incidence surface is connected with the light exiting surface and the bottom surface;
a diffuse reflector, secured to the bottom surface of the light guide plate by an adhesive pattern layer, wherein the adhesive pattern layer comprises a plurality of light-transmissive adhesive gels, and the light-transmissive adhesive gels do not comprise diffusive particles.

2. The light guide module of claim 1, wherein the diffuse reflector comprises a foam-molding type of white reflector or a reflector comprising a plurality of microstructures.

3. The light guide module of claim 2, wherein the foam-molding type of white reflector and the reflector comprising the microstructures are respectively integrally formed.

4. The light guide module of claim 1, wherein the diffuse reflector comprises a flexible material.

5. The light guide module of claim 1, wherein a refractive index of the light-transmissive adhesive gels is greater than a refractive index of air.

6. The light guide module of claim 5, wherein the refractive index of the light-transmissive adhesive gels is greater than or equal to a refractive index of the light guide plate.

7. The light guide module of claim 1, wherein a density of the light-transmissive adhesive gels increases as a distance of the light-transmissive adhesive gels from the light incidence surface increases.

8. The light guide module of claim 1, wherein a size of the light-transmissive adhesive gels increases as a distance of the light-transmissive adhesive gels from the light incidence surface increases.

9. The light guide module of claim 1, wherein the light guide plate comprises a flat type light guide plate or a wedge shape light guide plate.

10. A backlight module, comprising:
a light guide plate, comprising a light incidence surface, a light exiting surface, and a bottom surface, wherein the light exiting surface is opposite to the bottom surface, and the light incidence surface is connected with the light exiting surface and the bottom surface;
a light source, disposed at a side of the light incidence surface of the light guide plate, and the light source capable of providing a light beam; and
a diffuse reflector, secured to the bottom surface of the light guide plate by an adhesive pattern layer, wherein the adhesive pattern layer comprises a plurality of light-transmissive adhesive gels, and the light-transmissive adhesive gels do not comprise diffusive particles.

11. The backlight module of claim 10, wherein the diffuse reflector comprises a foam-molding type of white reflector or a reflector comprising a plurality of microstructures.

12. The backlight module of claim 11, wherein the foam-molding type of white reflector and the reflector comprising the microstructures are respectively integrally formed.

13. The backlight module of claim 10, wherein the diffuse reflector comprises a flexible material.

14. The backlight module of claim 10, wherein a refractive index of the light-transmissive adhesive gels is greater than a refractive index of air.

15. The backlight module of claim 14, wherein the refractive index of the light-transmissive adhesive gels is greater than or equal to a refractive index of the light guide plate.

16. The backlight module of claim 10, wherein a density of the light-transmissive adhesive gels increases as a distance of the light-transmissive adhesive gels from the light incidence surface increases.

17. The backlight module of claim 10, wherein a size of the light-transmissive adhesive gels increases as a distance of the light-transmissive adhesive gels from the light incidence surface increases.

18. The backlight module of claim 10, wherein the light guide plate comprises a flat type light guide plate or a wedge shape light guide plate.

19. The backlight module of claim 10, wherein the light beam of the light source is capable of passing through the light incidence surface to enter the light guide plate, and when the light beam transmitting inside the light guide plate is transmitted to the bottom surface in contact with the light-transmissive adhesive gels, the light beam is emitted from the bottom surface, enters into the light-transmissive adhesive gels, and is transmitted to the diffuse reflector in contact with the light-transmissive adhesive gels, and the light beam is diffused by the diffuse reflector and is reflected to the light guide plate, and is emitted from the light exiting surface.

20. A fabrication method of a light guide module, the fabrication method comprising:
providing a light guide plate comprising a light incidence surface, a light exiting surface, and a bottom surface;
providing a diffuse reflector; and
applying an adhesive pattern layer to secure the diffuse reflector to the bottom surface of the light guide plate, wherein the adhesive pattern layer comprises a plurality of light-transmissive adhesive gels, and the light-transmissive adhesive gels do not comprise diffusive particles.

21. The fabrication method of claim 20, wherein the step of securing the diffuse reflector to the bottom surface of the light guide plate comprises:
forming the adhesive pattern layer on the diffuse reflector; and
bonding the diffuse reflector comprising the adhesive pattern layer to the bottom surface of the light guide plate.

22. The fabrication method of claim 21, wherein the step of forming the adhesive pattern layer on the diffuse reflector comprises performing a screen printing process, a printing process, or a coating process.

23. The fabrication method of claim 20, wherein the step of securing the diffuse reflector to the bottom surface of the light guide plate comprises:
forming the adhesive pattern layer to the bottom surface of the light guide plate; and
disposing the diffuse reflector at the bottom surface of the light guide plate comprising the adhesive pattern layer.

24. The fabrication method of claim 23, wherein forming the adhesive pattern layer at the bottom surface of the light guide plate comprises performing a screen printing process, a printing process, or a coating process.
